(19) United States
(12) Patent Application Publication
(10) Pub. No.: US 2026/0368705 A1
(43) Pub. Date: Nov. 19, 2026

(54) DIGITAL TOKENIZATION AND CONVERSION OF ASSETS FOR COMBINED ONLINE EXCHANGE PLATFORM

(71) Applicant: Green Exchange, PBC, New York, NY (US)

(72) Inventors: Daniel Mark Labovitz, New York, NY (US); Charles Paul Dolan, Gladstone, NJ (US)

(21) Appl. No.: 19/680,642

(22) Filed: May 18, 2026

Related U.S. Application Data
(60) Provisional application No. 63/807,469, filed on May 16, 2025.
(60) Provisional application No. 63/809,283, filed on May 20, 2025.

(51) Int. Cl. G06Q 20/06; G06Q 20/36

(52) U.S. Cl. CPC G06Q 20/065; G06Q 20/36; G06Q 2220/00

(57) ABSTRACT

Digital tokenization and conversion of assets for combined online exchange platform are provided. Such a combined digital exchange platform may include a single order display book that maintains certain data linkages between digital tokens and assets and a translation layer executable to convert digital tokens for use in an order corresponding to a set of different exchange transactions with different online parties. A given token-based order may be verified by executing a smart contract and automated instructions being executed to coordinate the trade across the different systems. The order thus be translated into a corresponding order that mimics various aspects of the token order. The respective order books may then be updated and synchronized once the trade is cleared and settled, and digital tokens may be minted based on the cleared and settled trade.

### CROSS-REFERENCE TO RELATED APPLICATIONS

The present patent application claims the priority benefit of U.S. provisional patent application number 63/807,469 filed May 16, 2025 and U.S. provisional patent application number 63/809,283 filed May 20, 2025, the disclosures of which are incorporated by reference herein

### BACKGROUND OF THE CLAIMED INVENTION

### 1. Field of the Invention

The present invention generally relates to tokenization and generation of digital tokens representative of different aspects of a given asset. More specifically, the present invention relates to digital tokenization and conversion of assets for combined online exchange platform.

### 2. Description of the Related Art

There are presently bifurcated online platforms used to exchange digital tokens versus the assets represented by the digital tokens, which results in inefficiency when exchanges involving digital tokens and assets are desired. For example, centralized account-based systems do not allow for different aspects of an asset to be transacted individually (e.g., exchanged with different parties). Account-based systems require that such aspects be bound together into a single unit that cannot be sub-divided so as to allows for different dispositions across different parties.

There is, therefore, a need in the art for improved systems and methods for digital tokenization and conversion of assets for combined online exchange platform.

### SUMMARY OF THE CLAIMED INVENTION

Embodiments of the present invention include systems and methods for digital tokenization and conversion of assets for combined online exchange platform. Such a combined digital exchange platform may include a single order display book that maintains certain data linkages between digital tokens and assets and a translation layer executable to convert digital tokens for use in an order corresponding to a set of different exchange transactions with different online parties (e.g., designated digital custodians, GIDX, GIX, DTC, NSCC). Various embodiments and implementations are described in further detail herein.

### BRIEF DESCRIPTION OF THE DRAWINGS

FIG. 1 illustrates an exemplary network environment in which systems for managing online workflows for digital tokenization and asset conversion may be implemented.

FIG. 2 is a block diagram illustrating an exemplary digital token that can represent an asset and tracked in a distributed ledger.

FIG. 3 is a block diagram illustrating exemplary consecutive blocks of a blockchain ledger that may be used to track assets.

FIG. 4 is a flowchart illustrating an exemplary method for managing integrated online workflows for digital tokenization and asset conversion.

FIG. 5 illustrates an exemplary computing system hat may be used to implement an embodiment of the present invention.

### DETAILED DESCRIPTION

Embodiments of the present invention pertain to digital tokenization and conversion of assets for combined online exchange platform. Such a combined digital exchange platform may include a single order display book that maintains certain data linkages between digital tokens and assets and a translation layer executable to convert digital tokens for use in an order corresponding to a set of different exchange transactions with different online parties (e.g., designated digital custodians, GIDX, GIX, DTCC/NSCC). As used herein, GIDX refers to digital asset management platform for trading digital tokens representative of certain aspects of securities; GIX refers to an exchange platform that serves as central execution platform for both token-originated and traditional securities transactions. Together, GIX and GIDX provide an integrated ecosystem that allows for coordination of complex transactions involving token-originated and traditional exchange features. Depository Trust & Clearing Corporation (DTCC) and the National Securities Clearing Corporation (NSCC) refer to existing centralized securities clearing and settlement infrastructure used to process traditional securities trades and support settlement for the integrated GIX/GIDX ecosystem. Various embodiments and implementations are described in further detail herein.

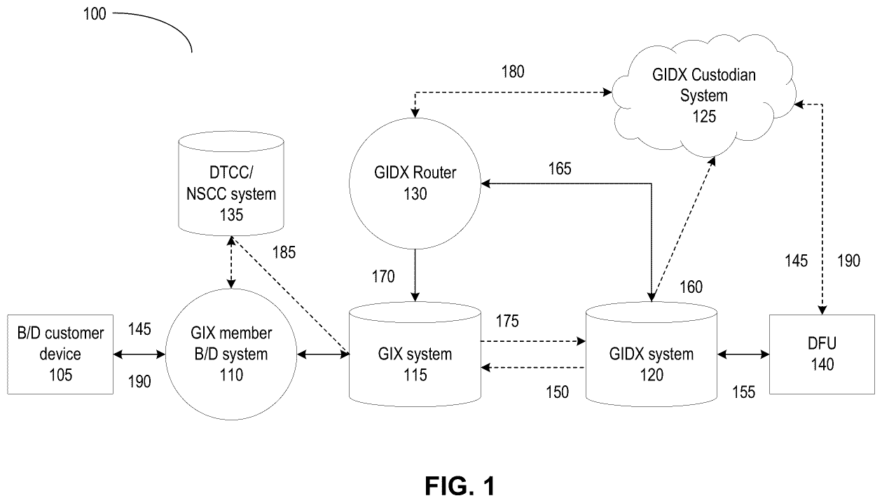

FIG. 1 illustrates an exemplary network environment 100 in which systems for managing online workflows for digital tokenization and asset conversion may be implemented. Network environment 100 may include a variety of different systems and devices capable of online communications and interactions, including B/D customer device(s) 105, GIX member B/D system(s) 110, GIX system 115, GIDX system 120, GIDX custodian system 125, GIDX router 130, DTCC/NSCC system 135, and DFU device 140

Broker-dealer (B/D) customer devices 105 are associated with broker-dealer customer accounts associated with traditional securities market participants who seek to trade conventional shares through a registered broker-dealer (such as connected to the GIX system 115). B/D customer devices 105 may access online markets through GIX member broker-dealer systems 110, as well as submit buy or sell orders for traditional share-denominated securities. The orders may interact with both traditional share liquidity and translated token-originated liquidity from GIDX system 120. After trades are cleared and settled through standard DTCC/NSCC processes and settlement, the GIX member B/D system 115 credits the associated account of the B/D customer device(s) 105 with shares or cash.

While the B/D customer device may engage in operations presented in accordance with conventional securities infrastructure, the combined GIX system 115 and GIDX system 120 provide a translation layer that enables interoperability with digital token participants without requiring the B/D customer device 105 to interact directly with blockchain or token systems. The workflow positions the B/D customer device 105 as the traditional-market counterpart to DeFi/token device 140 (e.g., associated with a DFU user) in the integrated GIX/GIDX trading ecosystem.

The GIX member broker-dealer (B/D) system 110 is associated with a regulated intermediary that facilitates traditional share trading within the GIX system 115 and serves as the bridge between conventional securities markets and the tokenized asset ecosystem. The GIX member B/D system 110 also serves as the connection point between the traditional securities systems and the tokenized asset systems by processing translated orders originating from GIDX token participants (DFU 140). Although token liquidity is integrated into the market, the GIX member B/D system 110 may continue operating through standard regulated securities market infrastructure and procedures

As such, GIX member broker-dealer system 110 may manage and coordinate functions in support of the integrated platform for both traditional and tokenized transactions. Such functions may include onboarding traditional B/D customer devices 105 to the GIX system 115, receiving and submitting orders for traditional share-denominated securities transactions, entering orders into the GIX system 115 exchange order book, interacting with liquidity originating from both traditional share traders and token-originated orders translated from GIDX system 120, receiving translated orders from GIDX router 130 that originate from digital token participant device (DFU 140), coordinating standard securities market clearing and settlement through DTCC and NSCC, holding and settling shares or cash for the benefit of customer accounts, crediting customer accounts after settlement with shares or dollars, operating within existing regulated securities infrastructure while enabling interoperability with tokenized markets.

GIX member broker-dealer systems 110 may continue to use ordinary securities market processes and regulatory structures, while also supporting integration with tokenized transactions behind the scenes through the GIDX router 130, GIDX custodian systems 125, and corresponding translation processes that allow traditional market participants to access liquidity from token markets without directly interacting with blockchain systems.

GIX system 115 may be inclusive of a registered national securities exchange platform that serves as a central trading venue for both traditional shares and translated token-originated orders. GIX system 115 may maintain the primary order book, synchronize liquidity information with GIDX system 125, execute trades, and clear and settle transactions through standard DTCC/NSCC system 135 infrastructure. As such, GIX system 115 may function as the core regulated marketplace where both conventional securities participants and tokenized asset participants indirectly interact, enabling unified liquidity between share and token markets while preserving existing securities market structure and regulatory processes.

GIX system 115 may thus be responsible for coordinating such functions as operating as the regulated exchange for traditional share trading, maintaining and publishing the primary order book for combined share and token liquidity, serving as an authoritative source of truth for market state and order book information, receiving traditional orders from GIX member B/D systems 110, receiving translated token-originated orders from GIDX system 120 through the GIDX router 130; matching, executing, clearing, and settling trades using existing DTCC/NSCC system 135, publishing market data and liquidity information to GIDX system 120 to synchronize data for both markets, providing a unified marketplace platform where traditional shares and tokenized shares can interact seamlessly, allowing token participants to indirectly access regulated securities markets without directly trading shares themselves, and preserving existing securities regulatory and settlement structures while integrating tokenized liquidity. Although token participants interact through GIDX system 120 and GIDX custodian systems 125, all actual securities trading ultimately occurs through GIX system 115 using conventional regulated market processes.

GIDX system 120 provides a regulated digital asset marketplace for trading tokenized versions of securities and integrates with the traditional securities exchange (GIX system 115) through a translation and routing framework. Functioning as the token-side platform, GIDX system 120 receives orders from digital participant devices (DFU 140), verifies collateral and eligibility through custodians (GIDX custodian 125), synchronizes liquidity with GIX system 115, and routes translated token orders into the traditional securities exchange. GIDX system 120 thus acts as a translation layer between blockchain-based token markets and conventional securities infrastructure by coordinating token conversion, smart contract automation, and settlement workflows while relying on GIX system 115 and DTCC/NSCC systems 135 for actual trade execution and settlement.

GIDX system 120 itself does not directly clear and settle securities trades, but instead is tasked with functions related to operating a regulated digital asset market for tokenized shares, allowing digital participants (DeFi users/token holders associated with DFU 140) to trade tokenized securities, maintaining synchronized order book data with GIX system 115 to reflect combined liquidity across both markets, receiving token-denominated orders from digital participants (DFU 140), verifying participant eligibility and asset sufficiency through registered custodians (GIDX custodian system 125), routing translated token orders to GIX system 115 through the GIDX router 130 for execution as traditional share orders, acting as the translation layer between tokenized assets and traditional securities infrastructure, and enabling token traders to access liquidity from both token markets and traditional share markets. GIDX system 120 may further coordinate with custodians (GIDX custodian system 125) to lock, convert, mint, burn, and settle tokenized assets, as well as use smart contracts to automate verification, collateralization, conversion, and settlement processes in support of interoperability between blockchain-based digital asset systems and conventional securities clearing systems. GIDX system 120 primarily manages token-side workflows, order synchronization, and routing between the token and traditional securities environments.

The GIDX custodian system 125 is associated with a regulated intermediary that manages custody, verification, collateralization, conversion, and settlement of tokenized assets for digital participants in the GIDX system 120. GIDX custodian system 125 supports onboarding of users, verification as to eligibility and sufficient collateral, locking assets during trades, and ensuring that all tokenized securities remain fully backed by corresponding shares held in trust. Using blockchain-based smart contracts, the GI GIDX custodian system 125 automates token minting, token burning, conversion between tokens, shares, USDC, and fiat currency, and post-trade settlement delivery to participant wallets. GIDX custodian system 125 may also serve as the primary bridge between blockchain-based token systems and traditional securities settlement infrastructure while maintaining market integrity and preventing uncollateralized or fraudulent token activity. As such, GIDX custodian system 125 is responsible for safeguarding, verifying, converting, collateralizing, and settling tokenized assets within the integrated ecosystem provided by GIX system 115 and GIDX system 120.

GIDX custodian system 125 thus serve as the onboarding and verification entity for digital participants (DeFi users/token traders) and performing regulatory, compliance, fraud-prevention, and market integrity checks on digital participants before trading. In addition, GIDX custodian system 125 may verify that participants possess sufficient collateral (including tokens or USDC, to support trades), maintaining custody of digital assets and sequestering (locking) assets during pending trades to prevent double-spending or fraudulent transfers, and maintaining balanced collateralized accounts where all minted tokens are backed by equivalent shares held in trust. Further, GIDX custodian system 125 may also be responsible for minting tokenized securities when shares are received, burning tokenized securities when tokens are converted back into shares, converting between tokenized assets, shares, USDC, and fiat currency, and holding accounts at the GIDX router 130 for the benefit of token participants.

GIDX custodian system 125 may use blockchain-based smart contracts to automate verification, collateralization, conversion, and settlement functions. In addition, GIDX custodian system 125 may receive settlement instructions, execute confirmations from GIDX system 120 and GIDX router 130, deliver converted assets or newly minted tokens directly to participant wallets after settlement, and preserve market integrity by ensuring that token supply matches underlying share collateral and prevent phantom liquidity. GIDX custodian system 125 thus may provide a core trust and conversion layer that bridges blockchain-based token ownership with conventional securities settlement infrastructure.

GIDX router 130 may provide a routing and communication layer that connects the digital asset marketplace of the GIDX system 120 with the securities exchange of the GIX system 115. GIDX router 130 may receive translated token-originated orders from GIDX system 120, submit corresponding share orders onto GIX system 115 on behalf of GIDX custodian systems 125, and digital participants (DFU 140), and enable those orders to execute within the traditional securities market infrastructure. GIDX router 130 may also communicate trade execution and settlement information back to GIDX custodian systems 125, as well as trigger smart contract-based conversion and settlement processes involving shares, tokens, USDC, and fiat currency. GIDX router 130 thus serves as the operational bridge that enables interoperability between tokenized asset trading and conventional securities exchange systems.

In serving as the intermediary routing and communication component that connects the GIDX system 120 with the GIX system 115, GIDX router 130 may receive translated token-originated orders from GIDX system 120, enter corresponding share orders onto GIX system 115 on behalf of GIDX custodian systems 125 and token participants, routing orders that mirror the side, size, and price of token orders submitted on GIDX system 120. GIDX router 130 thus may act as the execution gateway between the token marketplace and the regulated securities exchange in receiving trade execution confirmations from GIX system 115, sending execution and settlement messages to GIDX custodian systems 125 to trigger smart contract-based conversion and settlement processes, facilitating delivery of shares or dollars resulting from settled trades for the benefit of custodians and digital participants, maintaining accounts for GIDX custodian systems 125 for settlement processing, and supporting synchronization between token-market activity and traditional securities-market execution. As such, the GIDX system 120 itself does not have to directly place orders on GIX systems, because GIDX router 130 may perform this function so as to allow token-originated orders to be treated as ordinary share orders within the GIX system 115 infrastructure.

Depository Trust & Clearing Corporation and the National Securities Clearing Corporation systems (DTCC/NSCC) 135 provide centralized clearing and settlement infrastructure that processes securities trades executed through GIX system 115. DTCC/NSCC system 135 thus provides electronic book-entry settlement, transfer shares and cash between broker-dealers, and support Continuous Net Settlement (CNS) processes that reduce settlement activity through transaction netting. Within the integrated ecosystem of GIX system 115 and GIDX system 120, all trades—including token-originated transactions routed from GIDX—ultimately clear and settle through standard DTCC/NSCC system 135 infrastructure, which preserves conventional settlement, custody, and regulatory processes while allowing the ecosystem to integrate tokenized asset trading with existing regulated securities market systems.

Within network environment 100, DTCC/NSCC system 135 supports conventional settlement processes for trades executed on GIX system 115, which allows DTCC/NSCC system 135 to also serve as the underlying infrastructure through which all GIX system 115 trades—including token-originated orders routed through GIDX system 120—are ultimately cleared and settled. DTCC/NSCC system 135 may thus deliver shares or dollars to GIX member B/D systems 110 and GIDX router 130 accounts for the benefit of traditional and digital participants, support custody structures where shares are immobilized and held through DTC nominee ownership structures (e.g., Cede & Co.), and enable settlement of token-related trades using existing regulated securities settlement systems without requiring separate blockchain-native securities settlement infrastructure.

DFU 140 (DeFi user device) may be inclusive of any user device associated with digital-market participants who trade tokenized securities through the GIDX system 120 platform using tokens and USDC stablecoins. DFUs 140 may onboard with a GIDX custodian system 125, which verifies eligibility and collateral before trades are permitted. DFUs 140 may submit token-based orders through GIDX system 120, where their orders are translated into corresponding share orders for execution on GIX system 15. During the trading process, the GIDX custodian 125 may lock collateral, manage token conversion, and use smart contracts to automate settlement and delivery of tokens or USDC back to the digital wallet of the DFU 140. While DFUs 140 interact with blockchain-based systems, the underlying securities trades ultimately execute and settle through traditional securities market infrastructure.

In exemplary workflows, one or more interactions for onboarding 145 may occur between B/D customer device 105 and GIX member B/D system 110, as well as between GIDX custodian system 125 and DFU 140. In particular, digital participants (DFU 140) may onboard with GIDX custodian system 125 before trading tokenized securities. Such onboarding 145 may include verification of participant identity and eligibility, regulatory and market integrity checks, fraud-prevention procedures, verification that the participant owns and controls sufficient trading assets (tokens or USDC), and establishment of custodial and smart contract relationships required for trading and settlement. GIDX custodian system 125 may confirm that the associated account has sufficient collateral, assets can be sequestered during pending trades, and the participant account can participate in blockchain-based settlement workflows. The onboarding process effectively prepares the DFU to participate in the integrated ecosystem of GIX system 115 and GIDX system 120 while ensuring that tokenized trading activity remains fully collateralized, compliant, and interoperable with traditional securities market infrastructure.

Meanwhile, traditional securities customer device 105 accounts may be onboarded through GIX member B/D systems 110. Such onboarding 145 may follow conventional securities market practices and include establishment of brokerage customer accounts and participation in standard securities clearing and settlement infrastructure. In some implementations, the B/D customer device does not interact directly with GIX system 115 or blockchain/token infrastructure. Instead, the B/D customer device 105 establishes a relationship with a GIX member B/D system 110, similar to a conventional brokerage account relationship in existing securities markets. Once onboarded, the B/D customer device can submit buy or sell orders for traditional share-denominated securities, which may then be routed through the GIX member B/D system 110 into the GIX system 115. Thus, B/D customer device 105 is able to have indirect access to liquidity originating from both traditional share traders and token-market participants because GIX system 115 integrates liquidity from GIDX system 120.

Synchronization 150 may occur with respect to GIX system 115 and GIDX system 120 continuously synchronize liquidity and market data in their respective order books so that both traditional share participants and token-market participants can access combined liquidity for the same security. Thus, GIX system 115 and GIDX system 120 may continuously exchange order book information to maintain synchronized market views. In some implementations, GIX system 115 may publish a proprietary real-time data feed (e.g., a drop copy) containing order information to GIDX system 120, which may then updates its order book using data provided by GIX system 115. Because token orders of the GIDX system 120 are translated into corresponding GIX share orders, the GIX system 115 order book reflects both traditional share liquidity and token-originated liquidity. Both GIX system 115 and GIDX system 120 may thus maintain data reflecting the same effective liquidity for a security regardless of whether orders originate from shares or tokens. The synchronized order books also reduce arbitrage opportunities and pricing inefficiencies between token and share markets, and result in a single order display book representing combined liquidity across both GIX system 115 and GIDX system 120. When orders are added, executed, or removed on GIX system 115, updated order book information is transmitted back to GIDX system 120 to keep both markets aligned in real time. It is GIX system 115 that serves as the authoritative source of truth for the combined market state. Synchronization 150 thus supports seamless interoperability between traditional securities trading and tokenized asset trading, as mutual order-book updating is central to eliminating fragmentation between the two marketplaces.

Order 155 may be sent by DFU 140 to GIDX system 120 using software provided by GIDX system 120 and may pertain to a token-denominated trade order for a specified quantity and price of a tokenized security (e.g., “XYZd”). Order 155 may further specify whether to buy or sell, quantity of tokens, and either a specific price or minimum/maximum price limits.

Upon receiving the order, verification 160 may then occur. Specifically, GIDX system 120 may communicate with the GIDX custodian system 125 to verify that the DFU 140 is onboarded and eligible to trade and that the account associated with the DFU 140 possesses sufficient collateral (tokens or USDC). The GIDX custodian system 125 may execute a smart contract to verify the DFU 140 collateral, sequesters or locks the assets supporting the trade, and prepares automated conversion instructions if the trade executes. GIDX system 120 may then treat the token order as an instruction to create a corresponding share order on GIX system 115.

Routing 160 may then occur in which GIDX system 120 routes the translated order through the GIDX router 130 on behalf of the GIDX custodian system 125, which submits a matching share order onto GIX system 115 for execution. Thus, a token-based order submitted on GIDX system 120 is translated into a corresponding traditional share order and routed to GIX system 115 through the GIDX router 130. The routed order 160 is designed to “mimic” the original token order by matching its side (buy or sell), size (quantity), and price terms. The GIDX router 130 then enters the mimicked order onto GIX system 115 as a conventional securities order. Once entered, GIX system 115 processes the order using its standard matching and execution logic alongside all other traditional share orders.

Real-time synchronization 175 may then occur by which GIX system 115 continuously communicates changes in market liquidity and trading activity back to the GIDX system 120. After the GIDX router 130 submits a translated share order onto GIX system 115, GIX system 115 processes the order using its normal exchange matching logic. If no matching contra-side order exists, GIX system 115 displays the order on its order book as available liquidity. If the order executes against available liquidity, GIX system 115 updates its order book to reflect the trade execution and removal of liquidity. In either case, GIX system 115 then transmits updated order book information back to GIDX system 120, which then uses this information to synchronize its own (GIDX system 120) order book so that token-market participants see the same effective liquidity and market state as participants trading directly on GIX system 115. The updated order-book state can include newly displayed orders, executed trades, removed liquidity, and other changes affecting available market interest. This synchronization 175 thus keeps both GIX system 115 and GIDX system 120 marketplaces aligned in real time, ensures that token and share markets reflect identical liquidity conditions, reduces pricing inefficiencies and arbitrage opportunities, and allows participants in either market to react to the same consolidated liquidity pool.

Settlement trigger 180 may then be communicated between the GIDX router 130 and the GIDX custodian system 125 following execution of a token-originated order on GIX system 115. Once GIX system 115 confirms the trade execution, confirmation may be sent to GIDX router 130, which then sends a message to the GIDX custodian system 125 that acts as a trigger that activates the execution of a smart contract-driven settlement workflow by GIDX custodian system 125. The smart contracts then initiate the processes necessary to clear and settle the transaction on behalf of DFU 140, including confirming execution details, releasing previously locked collateral, converting tokens into shares or converting USDC into fiat currency (or vice versa), coordinating receipt of shares or dollars delivered through DTCC/NSCC system 135 for settlement, minting new tokens if shares were acquired, burning tokens if shares are being delivered, and delivering resulting tokens or USDC to the digital wallet of DFU 140.

Standard settlement 185 instructions may then be provided to DTCC/NSCC system 135 in accordance with the trade by GIX system 115. DTCC/NSCC system 135 may then process the exchange of shares and cash between the parties involved in the transaction, and shares or dollars are delivered to the appropriate GIX member B/D system 110.

In an integrated settlement stage 190, GIX member B/D system 110 may then settle the trade with the B/D customer device 105 by crediting the associated account with shares or cash, while a concurrent delivery of corresponding shares or dollars is made to the GIDX router for the benefit of the GIDX custodian system 125 and DFU 140.

The workflows described herein may be implemented in a network environment that includes one or more communication networks that allow communication between the different systems, platforms, and devices associated with performance of the steps described. The communication networks may include local, proprietary networks (e.g., intranet) and/or may be a part of a larger wide-area network. The communications network may be a local area network (LAN), which may be communicatively coupled to a wide area network (WAN) such as the Internet. The Internet is a broad network of interconnected computers and servers allowing for the transmission and exchange of Internet Protocol (IP) data between users connected through a network service provider. Examples of network service providers are the public switched telephone network, a cable service provider, a provider of digital subscriber line (DSL) services, or a satellite service provider. Communications network allows for communication between the various components of network environment.

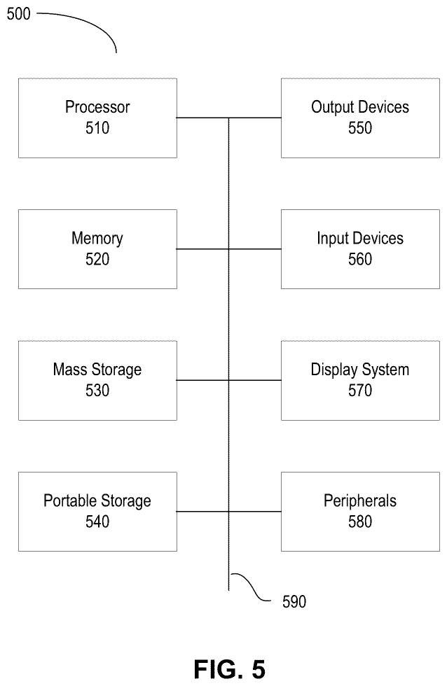

Different electronic systems, platforms, and devices that may be used to perform at least part of the steps described herein may be inclusive of servers, general purpose computers, mobile phones, smartphones, personal digital assistants (PDAs), portable computing devices (e.g., laptop, netbook, tablets), desktop computing devices, handheld computing device, or any other type of computing device capable of communicating over communication network. The systems, platforms, and devices may also be configured to access data from other storage media, such as memory cards or disk drives as may be appropriate in the case of downloaded services. The systems, platforms, and devices may include standard hardware computing components such as network and media interfaces, non-transitory computer-readable storage (memory), and processors for executing instructions that may be stored in memory such as described in relation to FIG. 5. The functionalities of multiple servers may be integrated into a single server, or certain functions may be distributed across multiple servers. Any of the aforementioned servers (or an integrated server) may take on certain client-side, cache, or proxy server characteristics. These characteristics may depend on the particular network placement of the server or certain configurations of the server.

The steps may be embodied as executable instructions embodied in a non-transitory computer readable storage media. The instructions of the storage medium may be executed by a processor (or processors) to cause various hardware components of a computing device hosting or otherwise accessing the storage medium to effectuate the method. The steps discussed herein (and the order thereof) are exemplary and may include various alternatives, equivalents, or derivations thereof including but not limited to the order of execution of the same.

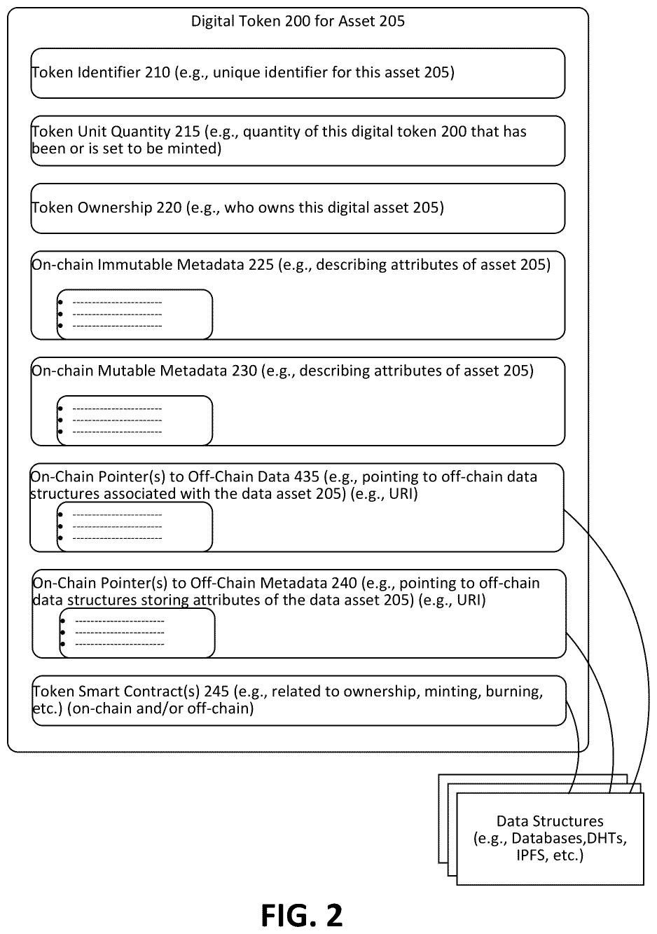

FIG. 2 is a block diagram illustrating an exemplary digital token 200 that can be non-fungible and that can represent an asset 205 and tracked in a distributed ledger, according to an aspect of the present disclosure. In some examples, the token 200 may be a non-fungible token (NFT). In some examples, the token 200 may be an ERC721 token, an ERC1155 token, an ERC-20 token, or a combination thereof. In some examples, the token 200 is tracked in a blockchain ledger 300. In some examples, the token 200 is tracked in an Ethereum-based blockchain ledger 300.

One or more token smart contracts 245 can be associated with the token 200. For instance, the one or more token smart contracts 245 manage creation (or “minting”) of the token 200. The one or more token smart contracts 245 can instruct miner devices that create (“mint”) a token 200, or batches of tokens, for computing time and resources taken to mint the token 200. The one or more token smart contracts 245 can control how ownership of the token 200 is decided and/or transferred. For instance, the one or more token smart contracts 245 can indicate an initial owner of the token 200 and/or can identify conditions under which ownership automatically transfers, for instance an offer meeting or exceeding an owner-mutable threshold amount. The one or more token smart contracts 245 can control conditions under which the token 200 can be burnt, or irreversibly destroyed and/or unlisted. The elements identified as part of the token 200 in FIG. 2—including the token identifier 210, the token unit quantity 215, the token ownership 220, the on-chain immutable metadata 225, the on-chain mutable metadata 230, the on-chain pointers to off-chain data 235, the on-chain pointers to off-chain metadata 240—can be stored as part of the token 200, can be part of the token smart contracts 245, or both. In some examples, the code of the token smart contracts 245 is stored at least partly on-chain. In some examples, the code of the token smart contracts 245 is stored at least partly off-chain at off-chain location(s) such as the data structures 140, with the off-chain location(s) identified by on-chain pointers to the off-chain location(s).

The token 200 includes a token identifier 210, which may be referred to as a tokenID. The token identifier 210 can be a unique identifier for the token 200 and/or for the asset 205. The token identifier 210 can be used to distinguish the particular instance of the asset 205 that the token 200 corresponds to from any other instance of the asset 205. In some examples, token identifiers can be created by a computing system creating (or “minting”) the token 200 by incremented sequentially compared to token identifiers of previously-created tokens, to ensure that each token identifier is unique.

The token 200 can include a token unit quantity 215. The token unit quantity 215 can identify a quantity of the token 200 that has been or is set to be minted. In some examples, the token unit quantity 215 is one, in which case a single token 200 exists for a given asset 205. In some examples the token unit quantity 215 is greater than one. For example, if the token unit quantity 215 is 5, then there are effectively 5 copies of this token 200 representing this unique asset 205 that can be owned and/or transferred separately. Those 5 copies may be fungible between one another, or indistinguishable from one another. However, those 5 copies are still non-fungible, unique, distinct, and/or distinguishable relative to any other instance or version or variant of the asset 205. The token unit quantity 215 can control how rare the token 200, and by extension the asset 205, is. If the token unit quantity 215 is one, then the token 200 and corresponding asset 205 is unique. If the token unit quantity 215 is more than one but less than a rarity threshold, then the token 200 and corresponding asset 205 is rare. If the token unit quantity 215 is more than one but more than a rarity threshold, then the token 200 and corresponding asset 205 is common. In some cases, the token unit quantity 215 can be decided as part of the minting process and/or identified in one of the token smart contracts 245 that manages the minting process.

The token 200 may identify a token ownership 220, which may identify who owns the token 200, and by extension, the corresponding asset 205. The token ownership 220 may initially be assigned to a creator of the asset 205. The token smart contracts 245 can control rules for transfer of token ownership 220. Token ownership 220 can be transferred as a transaction that is recorded as a payload element in a payload of a block of a blockchain ledger or other distributed ledger.

The token 200 may include on-chain immutable metadata 225. The on-chain immutable metadata 225 can include, for example, a description of the token 200, a description of the asset 205 that the token 200 represents, some immutable attributes or properties of the asset 205 and/or the token 200, or some combination thereof. The on-chain immutable metadata 225 can use properties of the distributed ledger and/or of the token smart contracts 245 to ensure that the on-chain immutable metadata 225 remains unchanged. In some examples, the on-chain immutable metadata 225 can identify where the data asset 205 is from, is a representation (e.g., recording) of, or is otherwise related to. In some examples, the on-chain immutable metadata 225 can identify a creator of the asset 205 and/or of the token 200.

The token 200 may include on-chain mutable metadata 230. The on-chain mutable metadata 230 can include, for example, a description of the token 200, a description of the asset 205 that the token 200 represents, some immutable attributes or properties of the asset 205 and/or the token 200, or some combination thereof. The on-chain mutable metadata 230 can be mutable or changeable. In some examples, a change to the on-chain mutable metadata 230 can be recorded as a transaction that is recorded as a payload element in a payload of a block of a blockchain ledger or other distributed ledger.

The token 200 may include on-chain pointers to off-chain data 235. The off-chain data can include the asset 205 and/or one or more representations of the asset 205. These types of data can require a lot of storage space to store, and can thus be expensive to store on-chain in terms of execution fee charges (such as gas on an Ethereum blockchain ledger). Thus, it may be more efficient to store this data off-chain in one or more off-chain locations, such as the data structures 140. The on-chain pointer can include a uniform resource identifier (URI), such as a uniform resource locator (URL), that points to the one or more network locations of the one or more off-chain locations. In some examples, hashes can be stored of the off-chain data, so that a verifying device can compute a hash of the off-chain data and compare the computed hash to the stored hash that is stored on-chain to verify that the off-chain data is accurate. In some examples, the off-chain data may be immutable. In some examples, the off-chain data may be mutable. In some examples, the pointer may be immutable. In some examples, the pointer may be mutable.

The token 200 may include on-chain pointers to off-chain metadata 240. The off-chain metadata 230 can include, for example, a description of the token 200, a description of the asset 205 that the token 200 represents, some immutable attributes or properties of the asset 205 and/or the token 200, or some combination thereof. Some assets 205 and/or tokens 200 may require significant quantities of metadata, which can require a lot of storage space to store, and can thus be expensive to store on-chain in terms of execution fee charges (such as gas on an Ethereum blockchain ledger). Thus, it may be more efficient to store this metadata off-chain in one or more off-chain locations, such as the data structures 140. The on-chain pointer can include a uniform resource identifier (URI), such as a uniform resource locator (URL), that points to the one or more network locations of the one or more off-chain locations. In some examples, hashes can be stored of the off-chain metadata, so that a verifying device can compute a hash of the off-chain metadata and compare the computed hash to the stored hash that is stored on-chain to verify that the off-chain metadata is accurate. In some examples, the off-chain metadata may be immutable. In some examples, the off-chain metadata may be mutable. In some examples, the pointer may be immutable. In some examples, the pointer may be mutable.

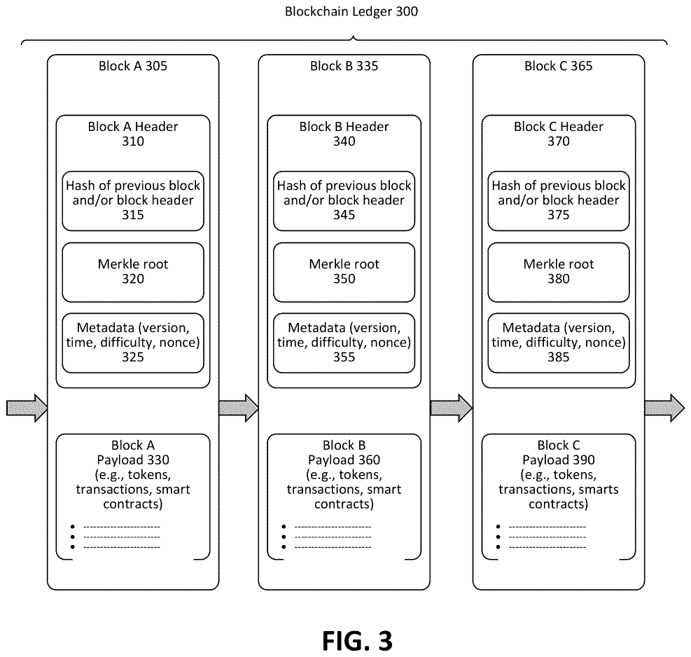

FIG. 3 is a block diagram illustrating three consecutive blocks of a blockchain ledger 300 that may be used to track an asset, according to an aspect of the present disclosure. Three blocks of the blockchain ledger 300 are illustrated in FIG. 3, including Block A 305, Block B 335, and Block C 365.

Each block includes a block header 310/340/370 and a list of one or more payloads 330/360/390. In some examples, block header 310/340/370 includes a hash 315/345/375 of the previous block and/or a hash 310/340/370 of the block header of the previous block. For instance, the header 370 of block C 365 includes a hash 375 of the header 340 of block B 335. The header 340 of block B 335 likewise includes a hash 345 of the header 310 of block A 305. The header 310 of block A 305 likewise includes a hash 315 of a header (not pictured) of previous block (not pictured) that is before block A 305 in the blockchain ledger 300. Including the hash of the previous block's header secures the blockchain ledger 300 by preventing modification of any block of the blockchain ledger 300 after the block has been entered into the blockchain ledger 300, as any change to a particular block would cause that block header's hash 315/345/375 in the next block to be incorrect. Further, modification of that block header's hash in the next block would make the next block's header's hash 315/345/375 in the block after the next block incorrect, and so forth. A verifying device can verify that a block has not been modified by computing the hash of block and/or of the block header, then comparing the computed hash to the stored hash 315/345/375 that is stored in the next block. In some distributed ledgers, a block header 310/340/370 can include hashes of multiple previous blocks and/or block headers of multiple previous blocks, as in a distributed acyclic graph (DAG) ledger.

Each block's block header 310/340/370 can include a Merkle root 320/350/380. The Merkle root 320/350/380 can be is generated based on hashes of each of the tokens, transactions, smart contracts, and/or other elements identified in the payload 330/360/390 for that block. Any attempt to modify a payload after the block has been entered would change the Merkle root. A verifying device can verify that the payload(s) 330/360/390 have not been modified by computing the Merkle root, then comparing the computed Merkle root to the stored Merkle root 320/350/380 that is stored in the block header 310/340/370. Changes to the payload 330/360/390 and/or to the Merkle root 320/350/380 would also change the hash for the block and/or for the block header, for which a value is stored in the next block as the hash 315/345/375. Each payload of each block may include one or more tokens (e.g., token 200), one or more transactions, one or more smart contracts, other content, or combinations thereof.

Each block's block header 310/340/370 may also include various elements of metadata, such as a version number for the blockchain ledger platform, a version number for the block itself, a timestamp for verification of each payload, a timestamp for generation of the block, a timestamp for entry of the block into the blockchain ledger 300, a timestamp for request of generation of the block, a difficulty target value (e.g., adjusting difficulty of mining), one or more randomized nonce values, a counter identifying how many nonces have been tried, a title of the blockchain ledger 300, an identifier as to what the blockchain ledger 300 is tracking (e.g., a history of an asset), or a combination thereof. Each individual element added can further serve as information that can be verified by a verifying device to identify if the block, and the payload within, is accurate and authorized. The one or more randomized nonce values can serve to further complicate the hashes, improving security.

Each block 305/335/365 of the blockchain ledger 300 also includes a payload 330/360/390. The payload 330/360/390 for each block 305/335/365 can include one or more tokens (e.g., token 200), one or more transactions, one or more smart contracts, one or more other elements, metadata related to any of the previously-listed elements, or combinations thereof. A token may be, for example, a non-fungible token. The token 200 may be an example of a token that is stored in the payload 330/360/390 for a block 305/335/365. As discussed with respect to the token 200, certain parts of the token 200 are stored within the payload 330/360/390 of the blockchain ledger 300, and are thus stored “on-chain.” As discussed with respect to the token 200, certain parts of the token 200 include on-chain pointers that point to data outside of the blockchain ledger 300, such as a data structure 140, with such data being stored “off-chain.” The payload 330/360/390 of the blockchain ledger 300 may store hashes of off-chain data, so that a verifying device can compute a hash of the off-chain data and compare the computed hash to the stored hash that is stored on-chain to verify that the off-chain data is accurate. In some examples, the payload 330/360/390 includes one or more smart contracts. The block may include the code of the smart contract stored within the payload 330/360/390 of the blockchain ledger 300, thus storing the code on-chain. If the payload 330/360/390 includes a smart contract, the block may include a hash of the code of the smart contract and/or a pointer to an off-chain data structure 140 storing the code of the smart contract, thus storing the code off-chain. In some examples, some of the smart contract's code may be stored on-chain, while some of the smart contract's code may be stored off-chain. In some examples, smart contracts can be used to create, modify, transfer, or otherwise manage tokens. In some examples, the payload 330/360/390 includes transactions. In some examples, transactions may include transfers of tokens from one account to another account. In some examples, transactions may include changes to certain properties of tokens or the associated assets, such as changes to ownership, attributes, or combinations thereof.

In one illustrative example, a first computing device can store a blockchain ledger including a plurality of blocks. Each of a plurality of computing devices (e.g., in a distributed architecture) also stores a copy of the blockchain ledger. The first computing device can receive a message identifying an intended payload element (e.g., token and/or transaction and/or smart contract). For example, the intended payload element may be a token related to one of the assets described herein. The first computing device can verify that the intended payload element is valid. In some blockchain ledger 300 implementations, the first computing device can verify that sufficient funds are allocated in order to pay for execution fee charges for the intended payload element, for instance in the form of gas on an Ethereum blockchain ledger. For a transaction, the first computing device can verify whether the transferor has a sufficient quantity of an asset (e.g., whether the transferor owns the token to be transferred) for the transaction to take place. For a smart contract, the first computing device can verify that the smart contract refers to valid accounts that include sufficient quantity or value of an asset (e.g., token) to execute the smart contract (e.g., to transfer the token), verify that the code of the smart contract can be executed (e.g., does not include syntax errors or other errors), verify that all parties involved in the smart contract have submitted agreement to the terms of the smart contract, or a combination thereof. For a token, the first computing device can verify details regarding the token.

The first computing device can generate a hash of a most recent block or block header of the blockchain ledger 300. The first computing device can generate a new block header for a new block. The new block header can include at least the hash of the most recent block or block header of the blockchain ledger 300. The first computing device can generate the new block, the new block including the new block header and a payload with one or more payload elements. The one or more payload elements include at least the intended payload element discussed above (e.g., token, smart contract, transaction). The first computing device can generate a Merkle root based on the payload elements, and include the Merkle root in the new block header. The first computing device can generate a metadata and a nonce value based on the payload elements, and include the metadata and the nonce value in the new block header. The first computing device can append the new block to the plurality of blocks of the blockchain ledger 300 in response to verifying the intended payload element. The first computing device can transmit the new block to the plurality of computing devices that each store the blockchain ledger 300 in response to verifying the intended payload element. Each of the plurality of computing devices also appends the new block to their respective copy of the blockchain ledger 300.

In another illustrative example, a first computing device can store a blockchain ledger 300 including a plurality of blocks. Each of a plurality of computing devices (e.g., in a distributed architecture) also stores a copy of the blockchain ledger 300. The first computing device can receive a UI input identifying an intended payload element (e.g., transaction and/or smart contract). The first computing device can generate a message identifying the intended payload element. The first computing device can retrieve a private key associated with an account corresponding to the first computing device. The first computing device can modify the message by encrypting at least a portion of the message with the private key. The first computing device can transmit the message to the plurality of computing devices other than the first computing device. A second computing device of the plurality of computing devices verifies that the intended payload element is valid, for instance as described in the previous paragraph. The first computing device receives a new block from the second computing device. The new block identifies and/or includes the intended payload element (e.g., in its payload). The first computing device appends the new block to the plurality of blocks of the blockchain ledger 300 at the first computing device.

While FIG. 3 only illustrates three blocks 305/335/365 of the blockchain ledger 300, it should be understood that any blockchain discussed herein may be longer or shorter in that it may have more or fewer than three blocks. Furthermore, it should be understood that another type of distributed ledger, such as a directed acyclic graph (DAG) ledger, can be used instead of, or in addition to, the blockchain ledger 300.

In some examples, a distributed ledger may have a non-linear ledger structure, such as that of a directed acyclic graph (DAG) ledger. Such a DAG ledger may be used instead of or in addition to the blockchain ledger 300 discussed herein. The term “distributed ledger” as used herein should be understood to refer to at least one of a blockchain ledger 300 (as in FIG. 3), a DAG ledger, or a combination thereof. In a DAG ledger, each block header includes the hashes of blocks (or block headers) of a number of other “parent” blocks in the DAG ledger, selected either at random or in some other non-linear manner, rather than just the hash 315/345/375 of a single previous block (or block header) as in the blockchain ledger 300. Where each block header includes multiple hashes corresponding to different parent blocks or their headers, these hashes can be combined together (e.g., using a Merkle root). In some examples, the number of parent blocks of a given block in a DAG ledger is predetermined. In some examples, the number of parent blocks of a given block in a DAG ledger is greater than or equal to a predetermined minimum number of parent blocks, such as a two-parent minimum or a one-parent minimum, meaning that each block has at least the predetermined minimum number of parent blocks. In some cases, each block in a DAG ledger may only identify only a single payload element (e.g., a smart contract, a token 200, a transaction) rather than multiple payload elements, and may therefore forego a Merkle root 320/350/380 of payload elements and/or replace it with a hash of the single payload element. In other implementations, each block may identify multiple payload elements associated with a predetermined time period, and/or may include a Merkle root 320/350/380 of the payload elements. In some examples, DAG ledgers may provide benefits over a blockchain ledger 300, for instance by providing parallelized validation, which may provide higher throughput and/or improved security compared to a blockchain ledger 300.

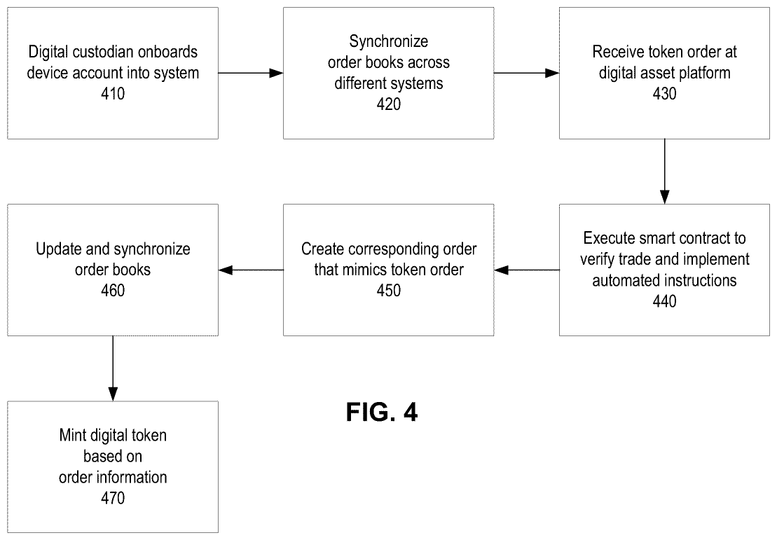

FIG. 4 is a flowchart illustrating an exemplary method for managing integrated online workflows for digital tokenization and asset conversion. As illustrated, the method may include onboarding a device account for digital token-based trades, synchronization of traditional and digital token-based order books maintained within separate systems, receipt of a token-based order, execution of a smart contract for verification purposes and automated instruction execution, creation of a corresponding order the mimics the token-based order, update and further synchronization of respective order books, and minting digital tokens based on order information.

In step 410, an account is created upon request by a DFU device 140 of a digital participant. The account may authorize the DFU 140 to trade tokenized securities on GIDX system 120 through a registered GIDX custodian system 125. During onboarding, the GIDX custodian system 125 may verify the participant's identity, eligibility, regulatory compliance, and ownership of sufficient collateral such as tokens or USDC. Once onboarded, the DFU 140 is permitted to submit token-based orders through GIDX system 120, while the GIDX custodian system 125 manages collateral locking, smart contract automation, asset conversion, and settlement delivery to the digital wallet associated with the DFU 140. The onboarding process ensures that digital trading activity is fully collateralized, compliant, and interoperable with traditional securities market infrastructure.

In step 420, GIX system 115 and GIDX system 120 share their respective order book data continuously and in real-time, including data regarding market liquidity across the traditional securities exchange (of GIX system 115) and the digital asset marketplace (of GIDX system 120). Accordingly, the respective order books of GIX system 115 and GIDX system 120 reflect the same effective liquidity for a given security. GIX system 115 may share its data by providing order information through a proprietary data feed or drop copy to GIDX system 120, which may then update its order book using this information. GIX system 115 may continuously send updated order-book states to GIDX so both systems remain synchronized as orders are entered, displayed, matched, executed, or removed. This synchronization allows traditional share traders (on GIX system 115) and digital token traders (on GIDX system 120) to view the same liquidity pool, as well as support seamless interactions between tokenized trading and conventional trading infrastructure.

In step 430, GIDX system 120 accepts a token-based trading instruction from the onboarded DFU 140 of digital participant. DFU 140 may use software provided by GIDX system 120 to submit an order for a tokenized security. The order may specify the tokenized security to be traded, whether the DFU 140 wants to buy or sell, the desired quantity, and the applicable pricing terms, such as a fixed price or minimum/maximum limit price.

In step 440, GIDX system 120 communicates with the GIDX custodian system 125 to verify that DFU 140 is properly onboarded and authorized to trade (e.g., the DFU 140 account possesses sufficient collateral in tokens or USDC), and the GIDX custodian 125 may execute smart contracts then sequester or lock the supporting assets to prevent double-spending or withdrawal during the pending transaction. Once verification is complete, GIDX system 120 may then treats the token order as an instruction to initiate a corresponding share order on GIX system 115.

In step 450, an order is created that mimics the token-based trading instruction submitted by DFU 140. GIDX system 120 translates the instruction into an equivalent traditional share order for execution on GIX system 115. The translated order is designed to mimic the original token order by reproducing the same transaction side (buy or sell), quantity, and pricing terms. GIDX system 120 may then route this mimicked order through the GIDX router 130 on behalf of the GIDX custodian system 125. The GIDX router 130 may then submit the order onto GIX system 115 as a conventional securities exchange order for processing using standard exchange matching logic and interaction with existing share-market liquidity. The mimicked order effectively allows a token-originated trade order to behave as if it were a normal share order inside the GIX system 115 environment.

In step 460, the order books of GIX system 115 and GIDX system 120 are synchronized to ensure both marketplaces reflect the same updated market state and liquidity conditions. Once the trade is matched, GIX system 115 updates its internal order book to reflect the executed trade, removal or reduction of consumed liquidity, and any remaining displayed order interest and transmits the updated order-book information back to GIDX system 120 through the data feed or drop file. GIDX system 120 may then update its own order book so digital-market participants see the same liquidity and execution results as participants trading directly on GIX system 115. The synchronized order books ensure that both the traditional securities market and the token marketplace remain aligned in real time. This synchronization after trade execution and clearing serves to maintain a unified liquidity pool, prevent stale or inconsistent market data, reduce arbitrage opportunities between token and share markets, and allow both traditional and digital participants to react to the same post-trade market conditions. The synchronized order-book framework is central to integrating tokenized asset trading with conventional securities exchange infrastructure while preserving standard clearing and settlement processes through DTCC/NSCC

In step 470, a digital token may be minted by GIDX custodian system 125 based on the cleared and settled trade. Once the GIDX custodian system 125 receives settled shares, the shares may be held in trust as collateral backing the tokenized asset, and a smart contract may be executed by GIDX custodian system 125 to initiate the minting process. Minting the digital token may include creating one or more new digital tokens representing the settled shares, ensuring the number of minted tokens matches the number of underlying collateralized shares, recording and managing the tokenized asset(s) through blockchain-based smart contracts, and delivering the newly minted tokens directly to the digital wallet of the DFU 140. Each minted token may be fully collateralized by corresponding shares held by the GIDX custodian system 125, which preserves one-to-one backing between traditional shares and tokenized representations, prevents creation of phantom liquidity, and maintains fungibility between shares and tokens. The minting process may be automated through smart contracts that coordinate receipt of settlement information, verification of collateral, token creation, and wallet delivery. In this way, a completed securities trade in the traditional market infrastructure results in creation of corresponding blockchain-based tokenized securities for the digital participant.

FIG. 5 illustrates an exemplary computing system 500 that may be used to implement an embodiment of the present invention. The computing system 500 of FIG. 5 includes one or more processors 510 and memory 520. Main memory 520 stores, in part, instructions and data for execution by processor 510. Main memory 520 can store the executable code when in operation. The system 500 of FIG. 5 further includes a mass storage device 530, portable storage medium drive(s) 540, output devices 550, user input devices 560, a graphics display 570, and peripheral devices 580.

The components shown in FIG. 5 are depicted as being connected via a single bus 590. However, the components may be connected through one or more data transport means. For example, processor unit 510 and main memory 520 may be connected via a local microprocessor bus, and the mass storage device 530, peripheral device(s) 580, portable storage device 540, and display system 570 may be connected via one or more input/output (I/O) buses.

Mass storage device 530, which may be implemented with a magnetic disk drive or an optical disk drive, is a non-volatile storage device for storing data and instructions for use by processor unit 510. Mass storage device 530 can store the system software for implementing embodiments of the present invention for purposes of loading that software into main memory 520.

Portable storage device 540 operates in conjunction with a portable non-volatile storage medium, such as a floppy disk, compact disk or Digital video disc, to input and output data and code to and from the computer system 500 of FIG. 5. The system software for implementing embodiments of the present invention may be stored on such a portable medium and input to the computer system 500 via the portable storage device 540.

Input devices 560 provide a portion of a user interface. Input devices 560 may include an alpha-numeric keypad, such as a keyboard, for inputting alpha-numeric and other information, or a pointing device, such as a mouse, a trackball, stylus, or cursor direction keys. Additionally, the system 500 as shown in FIG. 5 includes output devices 550. Examples of suitable output devices include speakers, printers, network interfaces, and monitors.

Display system 570 may include a liquid crystal display (LCD) or other suitable display device. Display system 570 receives textual and graphical information, and processes the information for output to the display device.

Peripherals 580 may include any type of computer support device to add additional functionality to the computer system. For example, peripheral device(s) 580 may include a modem or a router.

The components contained in the computer system 500 of FIG. 5 are those typically found in computer systems that may be suitable for use with embodiments of the present invention and are intended to represent a broad category of such computer components that are well known in the art. Thus, the computer system 500 of FIG. 5 can be a personal computer, handheld computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

The present invention may be implemented in an application that may be operable using a variety of devices. Non-transitory computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of non-transitory computer-readable media include, for example, a floppy disk, a flexible disk, a hard disk, magnetic tape, any other magnetic medium, a CD-ROM disk, digital video disk (DVD), any other optical medium, RAM, PROM, EPROM, a FLASHEPROM, and any other memory chip or cartridge.

Various forms of transmission media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU. Various forms of storage may likewise be implemented as well as the necessary network interfaces and network topologies to implement the same.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A system for digital tokenization and asset conversion, the system comprising:
memory that stores information regarding a digital token-based order book;
a communication interface that communicates over a communication network, wherein the communication interface receives an order for a tokenized version of an asset and one or more terms; and
a processor that executes instructions stored in memory to:
initiate execution of a smart contract to verify the received order and to implement automated instructions based on the verification,
create a corresponding order that mimics the terms of the received order in accordance with the automated instructions, wherein the corresponding order is created to be specific to the asset associated with the tokenized version,
continuously update the digital token-based order book based on information regarding the corresponding order, and
mint a digital token based on the information regarding the corresponding order as reflected by the updates digital token-based order book.

2. The system of claim 1, further comprising a custodian system that executes the smart contract.

3. The system of claim 2, wherein the order for the tokenized version of the asset is received from a participant device, and wherein the custodian system further onboards the participant device by creating a digital account and associating the digital account with the participant device.

4. The system of claim 3, wherein the communication interface further provides the minted digital token to a digital wallet associated with the participant device.

5. The system of claim 1, wherein the communication interface continuously receives a data feed associated with a source device designated as an authoritative source of truth, and wherein the digital token-based order book is continuously updated based on the data feed.

6. The system of claim 5, wherein the data feed corresponds to an order book associated with the designated source device, and wherein the digital token-based order book is continuously updated to reflect same data as the order book associated with the designated source device.

7. The system of claim 1, wherein the processor execute further instructions to settle another received order by performing one or more of minting a new digital token, converting an existing digital token, or burning an existing digital token.

8. A method for digital tokenization and asset conversion, the method comprising:
storing information in memory regarding a digital token-based order book;
communicating over a communication network via a communication interface to receive an order for a tokenized version of an asset and one or more terms; and
executes instructions stored in memory, wherein the instructions are executed by a processor to:
initiate execution of a smart contract to verify the received order and to implement automated instructions based on the verification,
create a corresponding order that mimics the terms of the received order in accordance with the automated instructions, wherein the corresponding order is created to be specific to the asset associated with the tokenized version,
continuously update the digital token-based order book based on information regarding the corresponding order, and
mint a digital token based on the information regarding the corresponding order as reflected by the updates digital token-based order book.

9. The method of claim 8, wherein the smart contract is executed by a custodian system.

10. The method of claim 9, wherein the order for the tokenized version of the asset is received from a participant device, and further comprising onboarding the participant device by creating a digital account and associating the digital account with the participant device.

11. The method of claim 10, further comprising providing the minted digital token to a digital wallet associated with the participant device.

12. The method of claim 8, further comprising continuously receives a data feed associated with a source device designated as an authoritative source of truth, wherein the digital token-based order book is continuously updated based on the data feed.

13. The method of claim 12, wherein the data feed corresponds to an order book associated with the designated source device, and wherein the digital token-based order book is continuously updated to reflect same data as the order book associated with the designated source device.

14. The method of claim 8, further comprising settling another received order by performing one or more of minting a new digital token, converting an existing digital token, or burning an existing digital token.

15. A non-transitory, computer-readable storage medium, having embodied thereon a program executable by a processor to perform a method for digital tokenization and asset conversion, the method comprising:
storing information in memory regarding a digital token-based order book;
communicating over a communication network via a communication interface to receive an order for a tokenized version of an asset and one or more terms;
initiating execution of a smart contract to verify the received order and to implement automated instructions based on the verification;
creating a corresponding order that mimics the terms of the received order in accordance with the automated instructions, wherein the corresponding order is created to be specific to the asset associated with the tokenized version;
continuously updating the digital token-based order book based on information regarding the corresponding order; and
minting a digital token based on the information regarding the corresponding order as reflected by the updates digital token-based order book.
